(19) United States
(12) Patent Application Publication
(10) Pub. No.: US 2025/0367639 A1
(43) Pub. Date: Dec. 4, 2025

(54) METHOD FOR MAKING NANOPOROUS CERIA AND USE THEREOF FOR AIR PURIFICATION

(71) Applicants: Mohamed Hamdy, Abha (SA); Amal Atran, Abha (SA); Nasser Awwad, Abha (SA); Fatma Abrahim, Abha (SA)

(72) Inventors: Mohamed Hamdy, Abha (SA); Amal Atran, Abha (SA); Nasser Awwad, Abha (SA); Fatma Abrahim, Abha (SA)

(21) Appl. No.: 18/733,286

(22) Filed: Jun. 4, 2024

(51) Int. Cl. B01J 23/10; B01D 53/02; B01D 53/86; B01J 20/06; B01J 20/28; B01J 20/30; B01J 23/83; B01J 23/847; B01J 23/86; B01J 35/39; B01J 35/40; B01J 35/64; B01J 37/08; C01B 32/50

(52) U.S. Cl. CPC B01J 23/10; B01D 53/02; B01D 53/864; B01J 20/06; B01J 20/2808; B01J 20/28083; B01J 20/3078; B01J 23/83; B01J 23/8472; B01J 23/86; B01J 35/39; B01J 35/40; B01J 35/643; B01J 35/647; B01J 35/651; B01J 37/08; C01B 32/50; B01D 2253/1124; B01D 2253/308; B01D 2255/2065; B01D 2255/20723; B01D 2255/20738; B01D 2255/20761; B01D 2255/20784; B01D 2255/802; B01D 2257/2064; B01D 2257/502; B01D 2257/702; B01D 2258/06; B01D 2259/4508

(57) ABSTRACT

A method for synthesizing functionalized porous cerium oxide nanoparticles and the resulting nanoparticles. The method involves preparing a synthesis mixture comprising a cerium source, two other metal sources, and an organic acid serving as a fuel. Volatile components are removed from the mixture, which is then subjected to thermal treatment in a static oven. The resulting nanoparticles have a three-dimensional structure with micropores and mesopores, oxygen-defects sites, 10 wt % of transition elements, and 1 wt % of tri-valent cations. The nanoparticles exhibit high photocatalytic activity and adsorption efficiency, and can be coated on a stainless steel substrate. The nanoparticles can be used for photocatalytic reactions, selective reduction and oxidation reactions, adsorption of specific compounds, and removal of toxic compounds from the air. The nanoparticles are coated on a chimney and allows for reduced hydrocarbons, carbon dioxide and carbon monoxide.

### COPYRIGHT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of nano-porous or porous chemical materials and processes, and more specifically, to a photocatalytic and adsorbent material, and its application in the conversion of organic pollutants found in the air, such as CO, CO2, and short-chain hydrocarbon gases.

### 2) Description of Related Art

Rapidly expanding industries produce a substantial volume of contaminants, including CO, CO2, and short-chain hydrocarbons, which are released into the air, contributing to significant air pollution. Some of these gases are highly toxic, and certain ones have been categorized as carcinogenic to humans. Consequently, researchers globally are exerting substantial efforts to develop cost-effective materials and advanced methods to tackle these environmental challenges and mitigate the dispersion of these pollutants. It is evident that there is a pressing need for an efficient approach to mitigate environmental pollution in all its manifestations, given its substantial economic implications.

Many contemporary air treatment methods rely on adsorption techniques, where activated carbon plays a significant role as an adsorbent. However, there is a continuous buildup of pollutants in the carbon filters, necessitating periodic regeneration. Additionally, activated carbon lacks photocatalytic activity. Zeolites, while exhibiting substantial adsorption capacity, face limitations due to their micropore structure, enabling adsorption only on the external surface and restricting their industrial utilization. On the other hand, titania and zinc oxide demonstrate superior photocatalytic activity under ultraviolet light but have limited activity under visible light. To address the challenges posed by these materials in air purification, a material with high surface area, wide pore diameter, substantial adsorption capacity, and robust photocatalytic activity under visible light was developed. Porous ceria was synthesized in a one-step procedure using organic molecules as a fuel in the thermal conversion of ceria precursors at elevated temperatures.

Cerium oxide, also known as ceria, is a powerful chemical compound having the chemical formula CeO2, and is characterized by its light yellowish color in its most common form. Being a rare earth metal oxide, cerium oxide is most commonly found in the earth's crust, but it is also readily synthesized in the lab for various applications.

Cerium oxide is derived primarily from certain rare earth minerals, including bastnasite and monazite. Bastnasite contains about 0.45% cerium, while monazite has an even higher cerium content, averaging around 3%. Extraction typically involves a complex series of chemical reactions and physical processes to isolate cerium from other elements and convert it to its oxide form.

Applications—Cerium oxide has found its applications in various industries owing to its unique chemical and physical properties. Some of the prominent industries and applications are:

Catalysis: Thanks to its excellent oxygen storage and release capabilities, cerium oxide is widely used as a catalyst, particularly in three-way catalytic converters in automobiles to reduce harmful emissions.

Polishing: Cerium oxide is used extensively in the glass industry, where it is used to polish high-grade optical surfaces.

Electronics: Due to its high refractive index and dielectric constant, cerium oxide has found its way into the field of electronics, particularly in the manufacture of capacitors and resistors.

Ceramics: Cerium oxide is used in the production of colored glazes in ceramics. It imparts yellow color to the ceramics.

UV Absorber: It can absorb UV rays and is hence used in the production of sunscreens and UV blocking glasses.

Medical: Emerging research suggests potential uses of cerium oxide in biomedicine, particularly as a neuroprotective agent due to its antioxidant properties. However, more research is required in this domain.

Health and Safety Aspects—Like many chemical substances, cerium oxide needs to be handled with care to ensure safety. While it is generally considered to have low toxicity, prolonged or excessive exposure can lead to health issues. Inhalation, for example, can cause respiratory tract irritation, while ingestion might lead to stomach irritation.

Nanoporous materials are a class of materials with a porous structure at the nanometer scale. These materials have a high surface area and are known for their ability to adsorb various substances. The high surface area of nanoporous materials makes them suitable for a variety of applications, including catalysis, adsorption, and gas storage.

Cerium oxide, also known as ceria, is a type of nanoporous material that has been widely studied due to its excellent chemical stability and high oxygen storage capacity. Ceria nanoparticles have been used in various applications, including as catalysts, in fuel cells, and in gas sensors.

Functionalization can be used to modify the properties of ceria nanoparticles. This involves the introduction of additional elements or compounds onto the surface of the nanoparticles. The functionalization of ceria nanoparticles can introduce new active sites, which can enhance their reactivity. For instance, the introduction of oxygen-defect sites can increase the redox activity of the nanoparticles, making them more effective catalysts. Similarly, the incorporation of transition elements and tri-valent cations can modify the electronic structure of the nanoparticles, thereby altering their reactivity.

Transition elements, such as iron, vanadium, chromium, and copper, are often incorporated into nanoporous materials to enhance their properties. These elements can improve the catalytic activity of the material, among other things. Similarly, trivalent cations, such as aluminum, gallium, and indium, can also be incorporated into nanoporous materials to modify their properties.

The flash combustion technique is a method used for the synthesis of nanoporous materials. This technique involves the rapid combustion of a precursor material to produce a nanoporous material. The flash combustion technique is known for its simplicity and efficiency, and it can be used to produce nanoporous materials with a high surface area.

Visible light illumination is often used in photocatalytic applications. Photocatalysis is a process in which light energy is used to speed up a chemical reaction. In the context of nanoporous materials, photocatalysis can be used to eliminate contaminants, such as short-chain hydrocarbons.

Smart chimney technology is a type of technology that uses nanoporous materials to filter and clean the air. The nanoporous material in the smart chimney can adsorb pollutants and contaminants from the air, improving air quality.

### BRIEF SUMMARY OF THE INVENTION

The instant invention in one form is directed to

The synthesis of functionalized porous ceria nanoparticles typically involves several steps. First, a synthesis mixture is prepared, which includes a cerium source, other metal sources, and an organic acid that serves as a fuel. This mixture is then subjected to a process to remove volatile components, followed by a thermal treatment to produce the nanoparticles. The choice of cerium source, other metal sources, and organic acid can influence the properties of the resulting nanoparticles.

The use of organic acids in the synthesis of ceria nanoparticles is noteworthy. These acids, which contain carboxyl groups (—COOH), can form hydrogen bonds with inorganic species such as cerium and heteroatoms. This can facilitate the formation of a gel during the initial stage of the synthesis process. Examples of organic acids that can be used in this context include citric acid, oxalic acid, lactic acid, formic acid, and acetic acid.

The resulting functionalized porous ceria nanoparticles can be characterized using various techniques. For instance, X-ray powder diffraction (XRD) can be used to determine their crystal structure, while transmission electron microscopy (TEM) can provide information about their morphology. Nitrogen sorption measurements can be used to determine their surface area and pore size distribution.

The disclosed process involves the preparation of (functionalized) nano-porous ceria and its application in air purification. The process includes: a) Providing a composition with a substantially nano-porous structure of cerium oxide (ceria) through a one-step procedure, comprising at least 80% by volume of pores with sizes ranging from about 2 nm to about 50 nm and a micropore volume of at least about 0.01 cc/g. The porous structure incorporates 10 wt % of iron and 1 wt % of aluminum or indium. b) Investigating the feasibility and effectiveness of the prepared materials in the adsorption of CO and CO2, as well as the photocatalytic degradation of various hydrocarbon gases under visible light illumination.

According to an aspect of the present disclosure, a method for fabrication of a nano porous cerium oxide is introduced. This method includes a one-pot sol-gel auto-combustion method. The fabrication process involves three functionalization: 1) creating an oxygen-defect rich surface, 2) incorporating 10 wt % of transition elements, and 3) adding 1 wt % of trivalent cations.

According to other aspects of the present disclosure, the method may result in materials that exhibit at least eight times higher surface area than the corresponding commercial ceria. The materials prepared through this method may show a nanoporous structure, as confirmed by scanning electron microscopic analysis and nitrogen sorption measurements.

In further aspects of the present disclosure, the materials prepared may exhibit high photocatalytic activity towards gaseous contaminants such as short-chain hydrocarbons under visible light illumination, specifically with a wavelength of halogen tubes centered at 425-450 nm. The adsorption efficiency of the prepared materials may exhibit high efficiency towards CO and CO2 gases.

According to additional aspects of the present disclosure, the prepared materials may be simply coated on stainless steel using a dip-coating technique with the assist of a suitable crosslinker. These materials can be utilized in the smart chimney technology.

The foregoing general description of the illustrative embodiments and the following detailed description thereof are merely exemplary aspects of the teachings of this disclosure and are not restrictive.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIGS. 1A and 1B show a diagrams of a synthesis technique and a coating in a chimney.

FIG. 2 shows a flow chart of the synthesis technique and coating of the synthesized product in the chimney.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

Functional materials are a group of engineered and advanced materials designed and synthesized for some specific function with proper surface morphology and tailored properties.

One aspect of the invention is directed to a method for fabrication of a nano porous cerium oxide including one-pot sol-gel auto-combustion method. The three functionalization are: 1) oxygen-defect rich surface, 2) 10 wt % of transition elements, and 3) 1 wt % of trivalent cations.

The prepared materials exhibit at least eight times higher surface area than the corresponding commercial ceria. The prepared materials show nanoporous structure as obtained from scanning electron microscopic analysis and nitrogen sorption measurements. The prepared materials exhibit high photocatalytic activity towards gaseous contaminants such as short-chain hydrocarbons under visible light illumination (wavelength of halogen tubes cantered at 425-450 nm). Adsorption efficiency of the prepared materials prepared in claim 1 exhibited high efficiency towards CO and CO2 gases. The prepared materials can be simply coated on stainless steel by using (dip-coating technique with the assist of suitable crosslinker. The prepared materials can be utilized in the smart chimney invention.

The material disclosed in the present invention comprises three-dimensional cerium oxide (ceria) nanoparticles characterized by a stable porous structure. This porous structure encompasses both micropores, with diameters less than 2 nm, and mesopores, with diameters ranging from 2 nm to 50 nm. The method for producing this porous ceria is detailed below.

The functionalization of nano porous ceria includes three main active sites: 1-oxygen-defects sites, 2-10 wt % of transition elements (titanium (Ti), vanadium (V), chromium (Cr), zinc (Zn), iron (Fe), tin (Sn), molybdenum (Mo), nickel (Ni), cobalt (Co), Zirconium (Zr), manganese (Mn), copper (Cu)), and 3-1 wt % of tri-valent cations (e.g. aluminum (Al), gallium (Ga), or indium (In)).

The production process of the porous ceria material involves the following steps:
1. Synthesis Mixture Preparation: The synthesis mixture comprises at least one cerium source, two other metal sources, and at least one organic acid serving as a fuel. These components are combined in an aqueous solution, typically forming a gel during the first stage of the catalyst preparation.
2. Removal of Volatile Components: The volatile components of the synthesis mixture, such as water and alcohol, are eliminated in an intermediate stage using conventional methods. Drying can be carried out with or without forced air flow at temperatures ranging from 40° C. to 100° C. for up to 24 hours.
3. Thermal Treatment: The synthesis mixture is subjected to thermal treatment in a static oven. This process is designed to eliminate all organic molecules, resulting in the production of nano-porous ceria.

In the initial stage, the cerium source, or precursor, may include cerium nitrates, cerium isopropoxide, cerium hydroxide, etc. Organic acids, preferably with carboxyl groups (—COOH), are utilized to form hydrogen bonds with inorganic species like cerium and heteroatoms. Examples of such organic acids are citric acid, oxalic acid, lactic acid, formic acid, and acetic acid. The heteroatom source, with or without organic groups, is typically introduced as a solution. For instance, in the case of iron, the source may be iron nitrate or iron chloride.

The incorporation of heteroatoms in the porous ceria enhances its suitability for photocatalytic reactions under visible light, resulting in the complete degradation of organic pollutants in liquid phases. This increased interest in applying photocatalysis extends to synthetic reactions such as selective reduction and oxidation, minimizing by-product formation. The prepared materials also exhibit effectiveness in selectively adsorbing specific compounds. The wide pores and functionalized pore walls enable various compounds to enter and interact with functional heteroatom groups. For example, incorporated heteroatoms with high but unsaturated coordination numbers can form coordination bonds with oxygen-, nitrogen-, and sulfur-containing compounds, effectively removing these substances from the air. Additionally, materials containing aluminum can perform base acid reactions, removing toxic compounds like chlorophenol from the air. Therefore, the prepared material serves as a suitable candidate for applications as adsorbents and molecular sieves.

The invention introduces a porous ceria with incorporated heteroatoms, featuring a randomly connected three-dimensional pore structure and a nano-porous arrangement. The disclosed method provides a cost-effective approach to synthesizing porous ceria without the need for surfactants, offering a quick and straightforward preparation procedure. The method is able to produce homogeneous multi-component oxides without an intermediate decomposition step. Furthermore, the method is scalable to industrial levels, requiring simple preparation equipment while maintaining precise control over compound stoichiometry. The invention brings forth diverse catalytic materials and processes, particularly for use in catalysis and separation.

In examples provided herein, X-ray powder diffraction patterns (XRD) of resulting materials were recorded using a Philips PW1840 diffractometer equipped with a graphite monochromator and CuK radiation. Scans were conducted in 0.02 steps from 5 to 40° 2θ. Transmission electron microscopy (TEM) was performed using a Philips CM30T electron microscope with a LaB6 filament at 300 kV. Nitrogen sorption isotherms at 77K were measured using the Quantachrome AutoSorb 6B. Mesoporosity was calculated using the Barrett, Joyner, and Halenda (BHJ) method. All compositions, unless specified otherwise, are presented in weight parts.

The present disclosure relates to a method for synthesizing functionalized porous cerium oxide (ceria) nanoparticles and the resulting nanoparticles themselves. In some aspects, the method involves preparing a synthesis mixture that includes at least one cerium source, two other metal sources, and at least one organic acid serving as a fuel. The volatile components of the synthesis mixture may be removed, and the synthesis mixture may be subjected to thermal treatment in a static oven to produce the functionalized porous ceria nanoparticles.

The resulting nanoparticles may have a three-dimensional structure encompassing micropores with diameters less than 2 nm and mesopores with diameters ranging from 2 nm to 50 nm. In some cases, the nanoparticles may include oxygen-defects sites, 10 wt % of transition elements, and 1 wt % of tri-valent cations. These nanoparticles may exhibit a surface area at least eight times higher than that of a corresponding commercial ceria, and may exhibit high photocatalytic activity towards gaseous contaminants such as short-chain hydrocarbons under visible light illumination.

The nanoparticles may be coated on a surface of a stainless steel substrate. The nanoparticles may be used for photocatalytic reactions under visible light, selective reduction and oxidation reactions, adsorption of specific compounds, and removal of toxic compounds from the air.

The method and resulting nanoparticles may provide several technical effects. For example, the method may allow for the production of nanoparticles with a stable porous structure, which may enhance their suitability for various applications, such as photocatalytic reactions and adsorption of specific compounds. The nanoparticles may also exhibit high photocatalytic activity and adsorption efficiency, which may be beneficial in various applications, such as the degradation of organic pollutants and the removal of toxic compounds from the air. These technical effects may address technical problems present in the field of nanoparticle synthesis and application, such as the difficulty in producing nanoparticles with a stable porous structure and high photocatalytic activity and adsorption efficiency.

The method for synthesizing functionalized porous cerium oxide (ceria) nanoparticles involves the preparation of a synthesis mixture. This mixture may include at least one cerium source, two other metal sources, and at least one organic acid serving as a fuel. The cerium source may be selected from a group consisting of cerium nitrates, cerium isopropoxide, and cerium hydroxide. The organic acid serving as a fuel may comprise a carboxyl group. In some cases, the organic acid serving as a fuel may be selected from a group consisting of citric acid, oxalic acid, lactic acid, formic acid, and acetic acid.

The synthesis mixture may be prepared by combining these components in an aqueous solution. In some cases, the combination of these components may result in the formation of a gel during the initial stage of the catalyst preparation. The cerium source, or precursor, may be introduced into the mixture in various forms, such as cerium nitrates, cerium isopropoxide, or cerium hydroxide.

The organic acid, which may comprise a carboxyl group, may serve as a fuel in the synthesis mixture. Examples of such organic acids may include citric acid, oxalic acid, lactic acid, formic acid, and acetic acid. These organic acids may form hydrogen bonds with inorganic species like cerium and heteroatoms, facilitating the synthesis process.

The preparation of the synthesis mixture may be a preliminary step in the production of functionalized porous ceria nanoparticles. This step may set the stage for subsequent processes, such as the removal of volatile components and thermal treatment, which may ultimately result in the production of the desired nanoparticles.

Following the preparation of the synthesis mixture, the method may involve the removal of volatile components from the mixture. This process may be carried out under specific conditions to ensure the effective removal of these components. In some cases, the removal of volatile components may be carried out at temperatures ranging from 40° C. to 100° C. This temperature range may be selected to facilitate the evaporation of volatile components without causing damage to the other components of the synthesis mixture.

The duration of this process may also vary depending on the specific conditions. In some aspects, the removal of volatile components may be carried out for up to 24 hours. This duration may be sufficient to ensure the complete removal of volatile components from the synthesis mixture. However, the exact duration may be adjusted based on factors such as the specific composition of the synthesis mixture and the temperature at which the process is carried out.

The removal of volatile components may be an integral part of the method for synthesizing functionalized porous cerium oxide (ceria) nanoparticles. This process may help to prepare the synthesis mixture for subsequent steps, such as thermal treatment, by eliminating components that could interfere with these processes. In some cases, the removal of volatile components may also contribute to the formation of the desired porous structure of the nanoparticles. For example, the removal of volatile components may create spaces within the synthesis mixture that become the pores of the nanoparticles during the thermal treatment process.

The removal of volatile components may be carried out using conventional methods. For instance, the synthesis mixture may be placed in an environment with a controlled temperature and humidity to facilitate the evaporation of volatile components. In some cases, the synthesis mixture may be subjected to a vacuum or a flow of inert gas to accelerate the removal of volatile components. The specific method used for the removal of volatile components may be selected based on factors such as the specific composition of the synthesis mixture and the desired properties of the resulting nanoparticles.

Following the removal of volatile components, the synthesis mixture may be subjected to thermal treatment. In some aspects, this thermal treatment may be carried out in a static oven. The thermal treatment process may be designed to eliminate all organic molecules, resulting in the production of functionalized porous ceria nanoparticles. The specific conditions of the thermal treatment, such as the temperature and duration, may be selected based on factors such as the specific composition of the synthesis mixture and the desired properties of the resulting nanoparticles.

The thermal treatment process may play a central role in the formation of the porous structure of the nanoparticles. During this process, the synthesis mixture may undergo a series of chemical reactions that lead to the formation of ceria nanoparticles with a stable porous structure. This porous structure may encompass both micropores, with diameters less than 2 nm, and mesopores, with diameters ranging from 2 nm to 50 nm. The formation of this porous structure may be facilitated by the removal of volatile components in the previous step, which may create spaces within the synthesis mixture that become the pores of the nanoparticles during the thermal treatment process.

The thermal treatment process may also contribute to the functionalization of the ceria nanoparticles. For instance, the thermal treatment may facilitate the incorporation of transition elements and tri-valent cations into the ceria nanoparticles, resulting in the formation of functionalized porous ceria nanoparticles. The specific transition elements and tri-valent cations incorporated into the nanoparticles may be selected based on factors such as the desired properties of the nanoparticles and the specific applications for which the nanoparticles are intended.

The thermal treatment process may be carried out using conventional methods. For instance, the synthesis mixture may be placed in a static oven and heated to a specific temperature for a specific duration. The specific temperature and duration may be selected to facilitate the elimination of organic molecules and the formation of the desired porous structure of the nanoparticles. In some cases, the synthesis mixture may be subjected to a controlled atmosphere during the thermal treatment process to further facilitate the formation of the desired nanoparticles.

The resulting functionalized porous ceria nanoparticles may exhibit a range of properties that make them suitable for various applications. For instance, the nanoparticles may exhibit a high surface area, which may enhance their suitability for applications such as photocatalytic reactions and adsorption of specific compounds. The nanoparticles may also exhibit high photocatalytic activity and adsorption efficiency, which may be beneficial in various applications, such as the degradation of organic pollutants and the removal of toxic compounds from the air.

The functionalized porous ceria nanoparticles, as produced by the method described, may exhibit a three-dimensional structure. This structure may encompass both micropores and mesopores. The micropores may have diameters less than 2 nm, while the mesopores may have diameters ranging from 2 nm to 50 nm. This porous structure may contribute to the high surface area of the nanoparticles, which may be at least eight times higher than that of a corresponding commercial ceria. The high surface area may enhance the nanoparticles' suitability for various applications, such as photocatalytic reactions and adsorption of specific compounds.

The functionalized porous ceria nanoparticles may include oxygen-defects sites. These sites may be created during the thermal treatment process, which may involve the elimination of all organic molecules from the synthesis mixture. The presence of oxygen-defects sites may contribute to the high photocatalytic activity of the nanoparticles, which may be beneficial in various applications, such as the degradation of organic pollutants and the removal of toxic compounds from the air.

The functionalized porous ceria nanoparticles may include 10% wt. of transition elements. These transition elements may be selected from a group consisting of titanium (Ti), vanadium (V), chromium (Cr), zinc (Zn), iron (Fe), tin (Sn), molybdenum (Mo), nickel (Ni), cobalt (Co), Zirconium (Zr), manganese (Mn), and copper (Cu). The incorporation of these transition elements into the nanoparticles may be facilitated by the thermal treatment process, which may involve the elimination of all organic molecules from the synthesis mixture.

The functionalized porous ceria nanoparticles may also include 1% wt. of tri-valent cations. These tri-valent cations may be selected from a group consisting of aluminum (Al), gallium (Ga), and indium (In). The incorporation of these tri-valent cations into the nanoparticles may be facilitated by the thermal treatment process, which may involve the elimination of all organic molecules from the synthesis mixture.

The functionalized porous ceria nanoparticles, as produced by the method described, may exhibit a range of properties that make them suitable for various applications. For instance, the nanoparticles may exhibit high photocatalytic activity towards gaseous contaminants such as short-chain hydrocarbons under visible light illumination. The nanoparticles may also exhibit high adsorption efficiency towards CO and CO2 gases. These properties may be attributed to the three-dimensional structure of the nanoparticles, the presence of oxygen-defects sites, and the incorporation of transition elements and tri-valent cations into the nanoparticles.

The functionalized porous ceria nanoparticles may exhibit high photocatalytic activity towards gaseous contaminants. This activity may be particularly pronounced for short-chain hydrocarbons when the nanoparticles are under visible light illumination. The high photocatalytic activity may be attributed to the three-dimensional structure of the nanoparticles, the presence of oxygen-defects sites, and the incorporation of transition elements and tri-valent cations into the nanoparticles. The high photocatalytic activity may enhance the nanoparticles' suitability for various applications, such as the degradation of organic pollutants and the removal of toxic compounds from the air.

The functionalized porous ceria nanoparticles may also exhibit high adsorption efficiency towards CO and CO2 gases. This high adsorption efficiency may be attributed to the three-dimensional structure of the nanoparticles, the presence of oxygen-defects sites, and the incorporation of transition elements and tri-valent cations into the nanoparticles. The high adsorption efficiency may enhance the nanoparticles' suitability for various applications, such as the removal of CO and CO2 gases from the air.

The high photocatalytic activity and adsorption efficiency of the functionalized porous ceria nanoparticles may be enhanced by the specific conditions of the thermal treatment process. For instance, the temperature and duration of the thermal treatment may be selected to facilitate the elimination of organic molecules and the formation of the desired porous structure of the nanoparticles. The specific transition elements and tri-valent cations incorporated into the nanoparticles may also contribute to their high photocatalytic activity and adsorption efficiency.

The functionalized porous ceria nanoparticles may be coated on a surface of a stainless steel substrate. This coating may enhance the nanoparticles' photocatalytic activity and adsorption efficiency, making them suitable for various applications, such as the degradation of organic pollutants and the removal of toxic compounds from the air. The specific method used for coating the nanoparticles on the substrate may be selected based on factors such as the specific composition of the nanoparticles and the desired properties of the resulting coated substrate.

The functionalized porous ceria nanoparticles may be coated on a surface of a stainless steel substrate. This coating process may involve the use of a suitable crosslinker and a dip-coating technique. The stainless steel substrate may be selected for its durability, resistance to corrosion, and compatibility with the nanoparticles. The coating of the nanoparticles on the substrate may form a layer that adheres well to the substrate, ensuring the stability of the nanoparticles on the substrate.

The coating of the nanoparticles on the stainless steel substrate may enhance the properties of the nanoparticles and expand their potential applications. For instance, the coated substrate may exhibit enhanced photocatalytic activity and adsorption efficiency, making it suitable for various applications, such as the degradation of organic pollutants and the removal of toxic compounds from the air. The coated substrate may also be used in devices such as smart chimneys, where the nanoparticles can interact with the gases passing through the chimney, facilitating the removal of contaminants.

The thickness of the nanoparticle coating on the stainless steel substrate may be adjusted based on the specific application. For instance, a thicker coating may be used for applications that require high photocatalytic activity and adsorption efficiency, while a thinner coating may be used for applications that require a lower level of these properties. The specific method used for coating the nanoparticles on the substrate, including the choice of crosslinker and the dip-coating technique, may be selected based on factors such as the specific composition of the nanoparticles, the desired properties of the resulting coated substrate, and the specific application for which the coated substrate is intended.

The coating of the nanoparticles on the stainless steel substrate may be carried out using conventional methods. For instance, the substrate may be dipped in a solution containing the nanoparticles and a suitable crosslinker, and then dried to form a coating of the nanoparticles on the substrate. The specific conditions of the coating process, such as the concentration of the nanoparticle solution and the drying temperature and duration, may be selected based on factors such as the specific composition of the nanoparticles and the desired properties of the resulting coated substrate.

The coated substrate may be subjected to further treatment processes to enhance the properties of the nanoparticle coating. For instance, the coated substrate may be heated to a specific temperature for a specific duration to facilitate the bonding of the nanoparticles to the substrate. The specific conditions of these treatment processes may be selected based on factors such as the specific composition of the nanoparticles and the desired properties of the resulting coated substrate.

The functionalized porous cerium oxide nanoparticles may be used in a variety of applications due to their high surface area, photocatalytic activity, and adsorption efficiency. In some aspects, the nanoparticles may be used for photocatalytic reactions under visible light. These reactions may involve the degradation of organic pollutants in liquid phases. The organic pollutants may be selected from a group consisting of chlorophenol, benzene, toluene, and xylene. The high photocatalytic activity of the nanoparticles may facilitate the degradation of these pollutants, contributing to the purification of the liquid phases.

The functionalized porous ceria nanoparticles may also be used for selective reduction and oxidation reactions. These reactions may involve the conversion of carbon monoxide to carbon dioxide. The high photocatalytic activity of the nanoparticles may facilitate these reactions, contributing to the reduction of carbon monoxide levels in the environment.

The functionalized porous ceria nanoparticles may be used for the adsorption of specific compounds. This process may involve the removal of sulfur-containing compounds from the air. The high adsorption efficiency of the nanoparticles may facilitate the removal of these compounds, contributing to the purification of the air.

The functionalized porous ceria nanoparticles may also be used for the removal of toxic compounds from the air. This process may be particularly beneficial for the purification of indoor air in residential or commercial buildings. The high adsorption efficiency of the nanoparticles may facilitate the removal of these toxic compounds, contributing to the improvement of indoor air quality.

The use of the functionalized porous ceria nanoparticles in these applications may be facilitated by their coating on a stainless steel substrate. The coating of the nanoparticles on the substrate may enhance their photocatalytic activity and adsorption efficiency, making them more effective in these applications. The specific method used for coating the nanoparticles on the substrate may be selected based on factors such as the specific composition of the nanoparticles, the desired properties of the resulting coated substrate, and the specific application for which the coated substrate is intended.

The prepared materials may be coated on stainless steel using a dip-coating technique with the assistance of a suitable crosslinker. This coating process may involve immersing the stainless steel in a solution containing the prepared materials and the crosslinker, followed by the removal of the stainless steel from the solution. The removal of the stainless steel may result in a thin layer of the prepared materials adhering to the surface of the stainless steel, forming a coating.

The crosslinker may serve to enhance the adhesion of the prepared materials to the stainless steel. In some cases, the crosslinker may be a compound that is capable of forming covalent bonds with both the prepared materials and the stainless steel, thereby linking them together. The type and amount of crosslinker used may be varied to suit specific applications and to achieve desired coating properties, such as thickness, uniformity, and adhesion strength.

The dip-coating technique may allow for the simple and efficient coating of the prepared materials on stainless steel. This technique may not require specialized equipment or complex procedures, making it suitable for use in various settings. The dip-coating technique may also allow for the coating of large areas of stainless steel, making it particularly suitable for applications where a large surface area of coated stainless steel is desirable, such as in smart chimney technology.

The dip-coating technique may be varied to achieve different coating properties. For example, changes in the concentration of the prepared materials in the solution, the duration of the immersion of the stainless steel in the solution, or the type and amount of crosslinker used may result in variations in the properties of the coating. These variations may allow for the tailoring of the coating to suit specific applications, such as smart chimney technology.

In summary, the prepared materials may be coated on stainless steel using a dip-coating technique with the assistance of a suitable crosslinker. This coating process may result in a thin layer of the prepared materials adhering to the surface of the stainless steel, forming a coating. The coating may enhance the properties of the stainless steel, such as its adsorption efficiency and photocatalytic activity, making it particularly suitable for use in applications where these properties are desirable, such as in smart chimney technology.

The prepared materials may be utilized in smart chimney technology. The smart chimney may be a device or system designed to improve air quality by removing gaseous pollutants, such as CO and CO2 gases, and short-chain hydrocarbons. The prepared materials, with their high surface area, nanoporous structure, and high photocatalytic activity, may be particularly suitable for use in such a system.

The prepared materials may be incorporated into the smart chimney in the form of a coating on the interior surfaces of the chimney. This coating may be applied using a dip-coating technique with the assistance of a suitable crosslinker, as previously described. The coating of the prepared materials on the interior surfaces of the chimney may allow for the direct contact of the gaseous pollutants with the prepared materials, thereby enhancing the removal of these pollutants.

The prepared materials may facilitate the adsorption of CO and CO2 gases in the smart chimney. The high surface area and nanoporous structure of the prepared materials may provide a large number of adsorption sites for these gases, thereby enhancing the efficiency of the adsorption process. The presence of oxygen defects on the surface of the cerium oxide may further enhance the adsorption efficiency, as these defects may provide additional sites for the adsorption of CO and CO2 gases.

In some cases, the prepared materials may facilitate the photocatalytic elimination of short-chain hydrocarbons in the smart chimney. The high photocatalytic activity of the prepared materials, particularly under visible light illumination, may promote the conversion of these hydrocarbons into less harmful substances. The light source for the photocatalytic process may be provided by the environment, such as sunlight, or by an artificial light source, such as halogen tubes with a wavelength centered at 425-450 nm.

The use of the prepared materials in the smart chimney may result in improved air quality. The removal of CO and CO2 gases and the photocatalytic elimination of short-chain hydrocarbons may reduce the concentration of these pollutants in the air, thereby improving air quality. This may be particularly beneficial in urban areas, where air pollution is a major concern.

The prepared materials of the present invention are used in smart chimney technology. The high surface area, nanoporous structure, and high photocatalytic activity of the prepared materials may enhance the removal of gaseous pollutants in the smart chimney, thereby improving air quality.

A number of implementations have been described. Nevertheless, it will be understood that various modifications may be made without departing from the spirit and scope of the disclosure. Accordingly, other implementations are within the scope of the following claims.

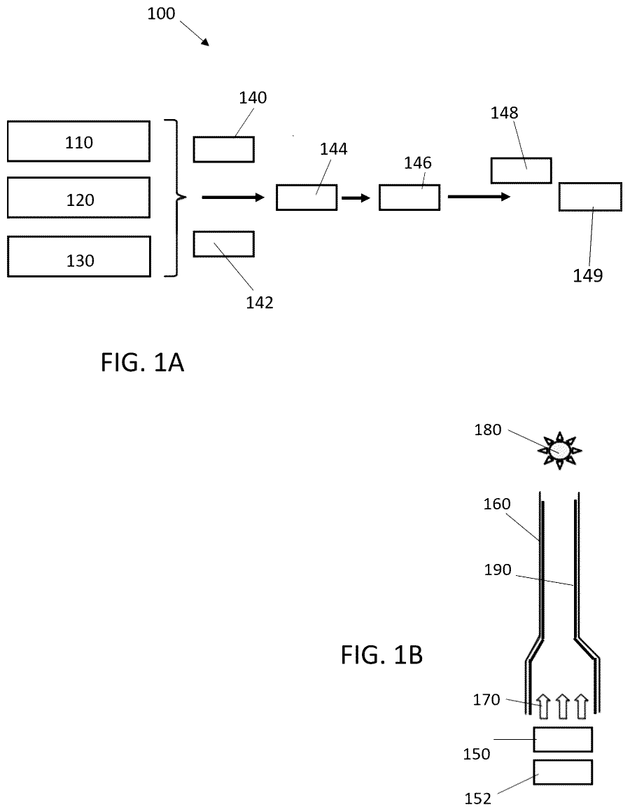

FIGS. 1A and 1B show diagrams of a synthesis technique 100 and a coating 190 in a chimney 160. Cerium 110 is combined with a transition element 120 and a trivalent cation 130. The trivalent cation is aluminum, gallium, indium or a combination thereof. The transition element is iron, vanadium, chromium, copper or a combination thereof. The process includes preparing a solution by mixing 140 and dissolving 142 the cerium 110, the transition element 120 and the trivalent cation 130. The solution is dried 144 until a solid compound is formed. The solid compound is then calcinated 146. The calcination 146 includes thermal treatment of the solid compound into a catalyst 149 whereby the solid compound is raised to high temperature without allowing melting of the solid compound while maintaining the solid compound under a restricted supply of oxygen. A chimney 160 is coated 148 with the catalyst 149, the coating 190 activated by a visible light source 180 such as the sun.

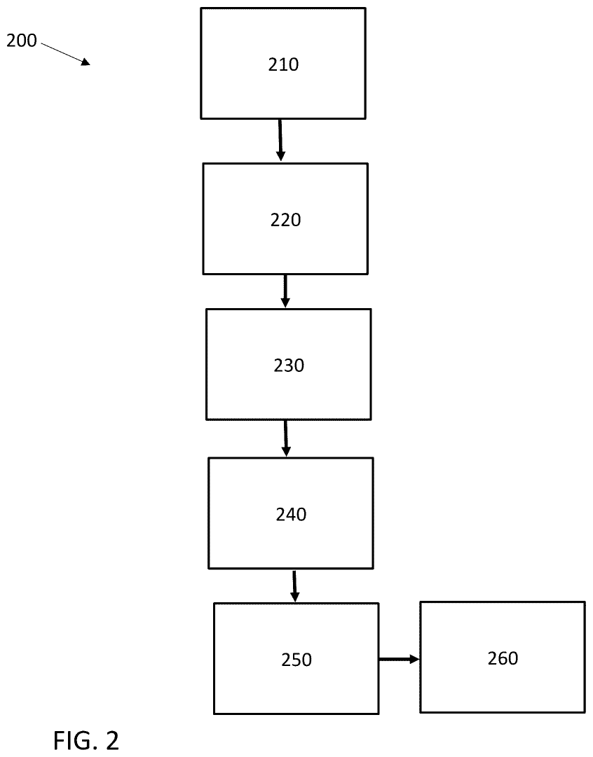

FIG. 2 shows a flowchart of the process 200 including preparing a solution 210 by mixing cerium, a transition element and a trivalent cation. The solution is dried 220 and then calcinated 230. The chimney is coated 240 with the calcinated cerium transitional element and trivalent cation. When a fuel burns 250 in the chimney, a visible light source allows byproducts of the burning process to react 260 with the catalyst to reduce the harmful byproducts of the burning of the fuel.

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for using functionalized porous cerium oxide nanoparticles for photocatalytic reactions under visible light, selective reduction and oxidation reactions, adsorption of specific compounds, and removal of toxic compounds from the air, the method comprising:
providing the functionalized porous cerium oxide nanoparticles;
coating a material with the functionalized porous cerium oxide nanoparticles;
exposing the material to visible light;
wherein the photocatalytic reactions under visible light are used for the degradation of organic pollutants in liquid phases.

2. The method according to claim 1 wherein the organic pollutants are selected from the group consisting of chlorophenol, benzene, toluene, and xylene.

3. The method according to claim 1 wherein the selective reduction and oxidation reactions are used for the conversion of carbon monoxide to carbon dioxide.

4. The method according to claim 1 wherein the adsorption of specific compounds is used for the removal of sulfur-containing compounds from the air.

5. The method according to claim 1 wherein the removal of toxic compounds from the air is used for the purification of indoor air in residential or commercial buildings.

6. A functionalized porous cerium oxide nanoparticle, comprising:
a three-dimensional structure having micropores with diameters less than 2 nm and mesopores with diameters ranging from 2 nm to 50 nm;
oxygen-defects sites;
10 wt % of transition elements; and
1 wt % of tri-valent cations.

7. The functionalized porous cerium oxide nanoparticle of claim 6, wherein the transition elements are selected from the group consisting of titanium (Ti), vanadium (V), chromium (Cr), zinc (Zn), iron (Fe), tin (Sn), molybdenum (Mo), nickel (Ni), cobalt (Co), Zirconium (Zr), manganese (Mn), and copper (Cu).

8. The functionalized porous cerium oxide nanoparticle of claim 6, wherein the tri-valent cations are selected from the group consisting of aluminum (Al), gallium (Ga), and indium (In).

9. The functionalized porous cerium oxide nanoparticle of claim 6, wherein the nanoparticle exhibits a surface area at least eight times higher than that of a corresponding commercial ceria.

10. The functionalized porous cerium oxide nanoparticle of claim 6, wherein the nanoparticle exhibits high photocatalytic activity towards gaseous contaminants such as short-chain hydrocarbons under visible light illumination.

11. The functionalized porous cerium oxide nanoparticle of claim 6, wherein the nanoparticle exhibits high adsorption efficiency towards CO and CO2 gases.

12. The functionalized porous cerium oxide nanoparticle of claim 6, wherein the nanoparticle is coated on a surface of a stainless steel substrate.

13. A method for preparing a nanoporous cerium oxide material, comprising:
synthesizing the nanoporous cerium oxide material using flash combustion, wherein the material comprises 10% transition elements and 1% trivalent cation incorporated into oxygen-vacancies rich porous cerium oxide nanoparticles; and
testing the material for CO2 adsorption and the photocatalytic elimination of short-chain hydrocarbons under visible light illumination.

14. The method of claim 13, wherein the transition elements are selected from the group consisting of iron, vanadium, chromium, and copper.

15. The method of claim 13, wherein the trivalent cation is selected from the group consisting of aluminum, gallium, and indium.

16. The method of claim 13, wherein the nanoporous cerium oxide material exhibits a surface area at least eight times higher than that of commercial ceria.

17. The method of claim 13, wherein the nanoporous cerium oxide material exhibits a nanoporous structure as confirmed by scanning electron microscopic analysis and nitrogen sorption measurements.

18. The method of claim 13, wherein the nanoporous cerium oxide material is tested for CO2 adsorption and the photocatalytic elimination of short-chain hydrocarbons under visible light illumination with a wavelength of halogen tubes centered at 425-450 nm.

19. The method of claim 13, wherein the nanoporous cerium oxide material is coated on stainless steel using a dip-coating technique with the assistance of a suitable crosslinker.
